(19) United States
(12) Patent Application Publication
(10) Pub. No.: US 2008/0022417 A1
(43) Pub. Date: Jan. 24, 2008

(54) System and Method For Securing Portable Computers

(76) Inventors: John M. Garrison, Austin, TX (US); Michael McKay, Round Rock, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/458,741

(22) Filed: Jul. 20, 2006

(51) Int. Cl. G06F 1/26; G06F 15/173

(52) U.S. Cl. 726/35; 709/224; 340/568.2

(57) ABSTRACT

A method, system, and computer-usable medium for laptop security. In a preferred embodiment of the present invention, a security manager establishes a desired network topology with a collection of laptops, wherein each of the collection of laptops communicates with other laptops within the collection of laptops utilizing a wireless connection. In response to establishing the desired network topology, the security manager causes the plurality of laptops to enter a lock down state. In response to detecting that a disruption in communication has occurred, the security manager issues an alarm.

### BACKGROUND OF THE INVENTION

1. Technical Field

The present invention relates in general to the field of data processing systems. More particularly, the present invention relates to the field of securing data processing systems. Still more particularly, the present invention relates to a system and method for securing portable computers.

2. Description of the Related Art

Despite the convenience and portability of laptop computers, security of stored data or the laptops themselves have always presented a challenge. Most conventional security devices involve cable locks, which affect portability. Also, locks do nothing to prevent an unauthorized user from tampering with the data stored on the laptop. Therefore, there is a need for a system and method for addressing the aforementioned limitations of the prior art.

### SUMMARY OF THE INVENTION

The present invention includes a method, system, and computer-usable medium for laptop security. In a preferred embodiment of the present invention, a security manager establishes a desired network topology with a collection of laptops, wherein each of the collection of laptops communicates with other laptops within the collection of laptops utilizing a wireless connection. In response to establishing the desired network topology, the security manager causes the plurality of laptops to enter a lock down state. In response to detecting that a disruption in communication has occurred, the security manager issues an alarm.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary network in which a preferred embodiment of the present invention may be implemented;

FIG. 2 is a block diagram depicting an exemplary data processing system in which a preferred embodiment of the present invention may be implemented; and

FIG. 3 is a high-level logical flowchart diagram illustrating an exemplary method of securing portable computers according to a preferred embodiment of the present invention.

### DETAILED DESCRIPTION OF A PREFERRED EMBODIMENT

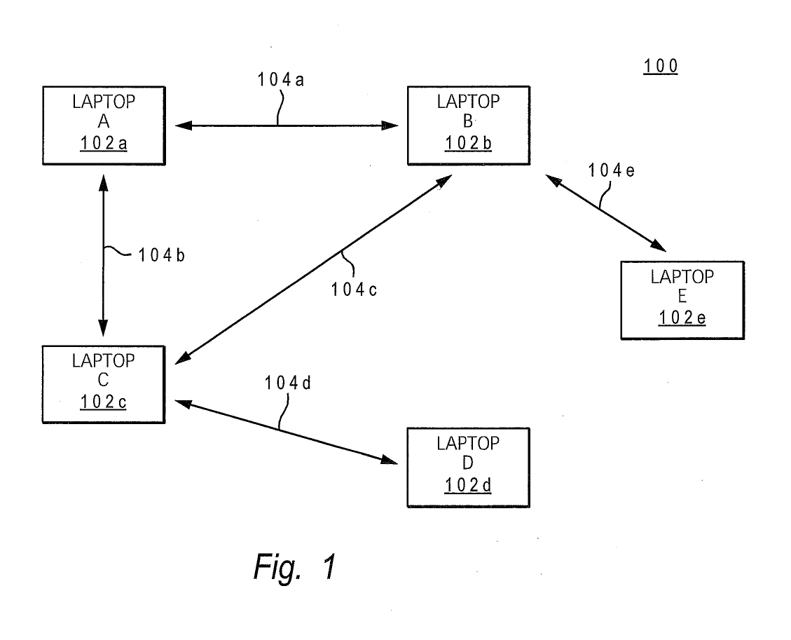

Referring now to the figures, and in particular, referring to FIG. 1, there is illustrated a block diagram depicting an exemplary network 100 in which a preferred embodiment of the present invention may be implemented.

As illustrated, exemplary network 100 includes a collection of laptops 102a-e, which is coupled by wireless connections 104a-e. In a preferred embodiment of the present invention, wireless connection 104a-e are implemented by infrared transmitters and receivers. Those with skill in the art will appreciate that wireless connections 104a-e may be implemented by any type of wireless connection including, but not limited to IEEE 802.11x, Ethernet, etc.

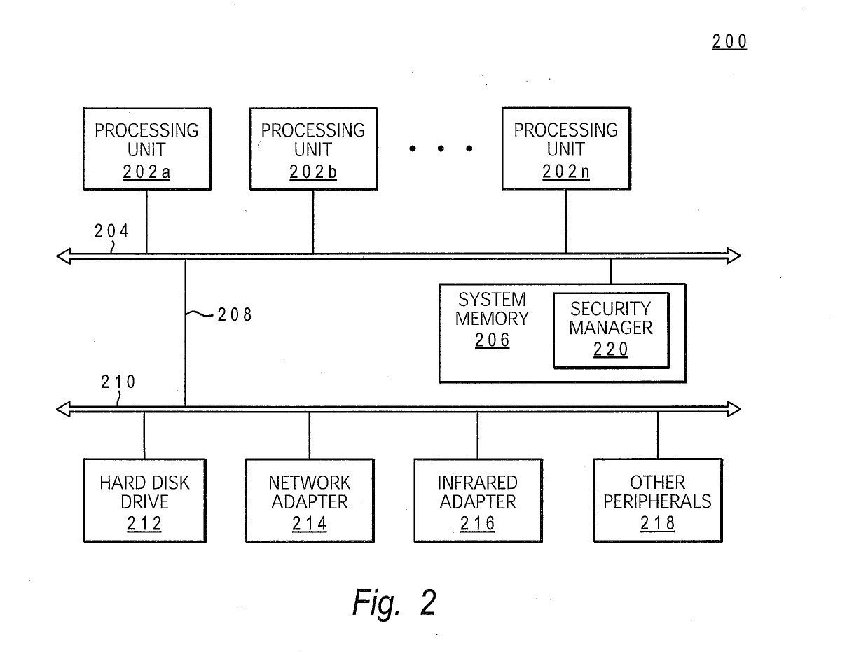

FIG. 2 is a block diagram depicting an exemplary data processing system 200 in which a preferred embodiment of the present invention may be implemented. According to a preferred embodiment of the present invention, data processing system 200 may be utilized to implement laptops 102a-e illustrated in FIG. 1. As depicted, data processing system 200 includes processing units 202a-n, which are coupled to system memory 206 by system interconnect 204. Coupling system interconnect 204 to peripheral interconnect 210 is mezzanine interconnect 208. Peripheral interconnect 210 couples hard disk drive 212, utilized for mass data storage, network adapter 214, infrared adapter 216, and other peripherals 218.

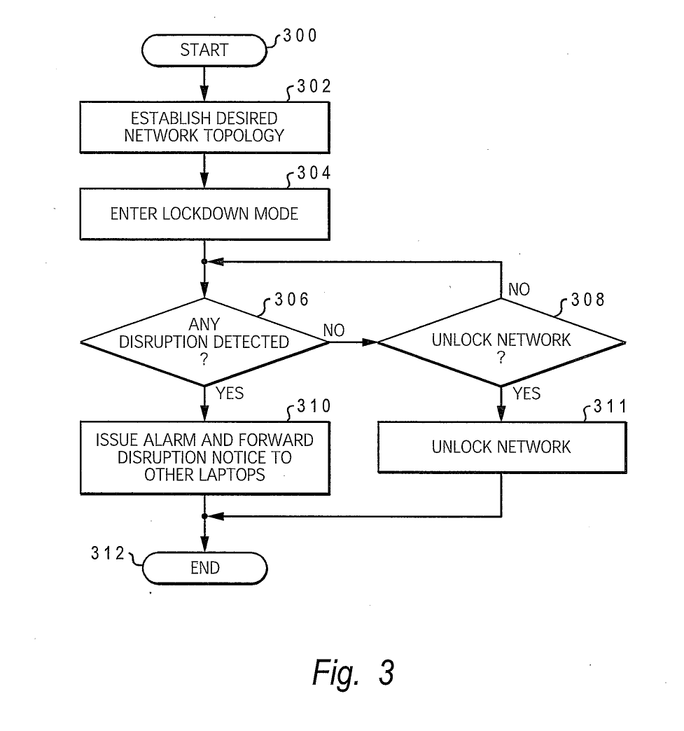

In a preferred embodiment of the present invention, network adapter may be implemented by any type of wireless communication adapter, such as an Ethernet or IEEE 802.11x adapter. Infrared adapter 216 maintains wireless connections 104a-e between laptops 102a-e, controlled by security manager 220, which is stored within system memory 206. The interaction between security manager 220, infrared adapter 216, network adapter 214, and security manager 220 will be discussed herein in more detail in conjunction with FIG. 3.

FIG. 3 is a high-level logical flowchart diagram illustrating an exemplary method of securing portable computer systems according to a preferred embodiment of the present invention. The process begins at step 300 and proceeds to step 302, which illustrates security manager 220 establishing a desired network topology. In a preferred embodiment of the present invention, establishing a desired network topology includes physically arranging laptops 102a-e in a desired configuration and establishing wireless connections 104a-e between laptops 102a-e via infrared adapter 216. Then, security manager 220 takes a “snapshot” of the established topology and may represent the topology, graphically or other wise, on a display on one of laptops 102a-e.

After the desired network topology has been established, the process continues to step 304, which depicts security manager 220 entering a lock down mode, which detects any variations or disruptions in the network configuration that differs from the earlier-established topology. The process proceeds to step 306, which illustrates security manager 220 determining if a disruption has been detected.

If a disruption has not been detected, the process continues to step 308, which depicts security manager 220 determining if a command to unlock network 100 has been received from a user. If an unlock command has not been received, the process returns to step 306 and proceeds in an iterative fashion. Returning to step 308, if an unlock command has been received, the process continues to step 311, which illustrates security manager 220 unlocking network 100. The process then ends, as depicted at step 312.

Returning to step 306, if a disruption to the established topology is detected, the process proceeds to step 310, which illustrates security manager 220 issuing an alarm and forwarding a disruption notice to other laptops 102a-e in network 100. In a preferred embodiment of the present invention, the alarm may include: all laptops in the arrangement issuing audible alarms, instant messages and/or email messages are immediately forwarded to a third party, if network connections via network adapter 214 are available, a shutdown of laptops 102a-e, locking the desktops of laptops 102a-e, and/or scrambling the contents of the hard disk drive. The process then ends, as illustrated in step 312.

As discussed, the present invention includes a method, system, and computer-usable medium for laptop security. In a preferred embodiment of the present invention, a security manager establishes a desired network topology with a collection of laptops, wherein each of the collection of laptops communicates with other laptops within the collection of laptops utilizing a wireless connection. In response to establishing the desired network topology, the security manager causes the plurality of laptops to enter a lock down state. In response to detecting that a disruption in communication has occurred, the security manager issues an alarm.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory, such as, but not limited to Random Access Memory (RAM), and communication media, such as computer and telephone networks including Ethernet, the Internet, wireless networks, and like network systems. It should be understood, therefore, that such signal-bearing media, when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as utilized in the specification and the appended claims, the term “computer” or “system” or “computer system” or “computing device” includes any data processing system including, but not limited to, personal computers, servers, workstations, network computers, mainframe computers, routers, switches, personal digital assistants (PDAs), telephones, and any other system capable of processing, transmitting, receiving, capturing, and/or storing data.

What is claimed is:

1. A method for laptop security, comprising:
establishing a desired network topology with a plurality of laptops, wherein each of said plurality of laptops communicates with other laptops utilizing a wireless connection;
in response to establishing said desired network topology, causing a plurality of laptops to enter a lock down state; and
in response to detecting that a disruption in communication has occurred, issuing an alarm.

2. The method according to claim 1, wherein said wireless connection includes at least one infrared transmitter and receiver.

3. The method according to claim 1, wherein said issuing an alarm further comprises:
forwarding a disruption notice to said other laptops.

4. The method according to claim 1, wherein said desired network topology includes physically arranging said plurality laptops in a desired configuration and establishing said wireless connection between said plurality of laptops.

5. A system for laptop security comprising:
a processor;
a databus coupled to said processor; and
a computer-usable medium embodying computer program code, said computer-usable medium being coupled to said databus, said computer program code comprising instructions executable by said processor and configured for:
establishing a desired network topology with a plurality of laptops, wherein each of said plurality of laptops communicates with other laptops utilizing a wireless connection;
in response to establishing said desired network topology, causing a plurality of laptops to enter a lock down state; and
in response to detecting that a disruption in communication has occurred, issuing an alarm.

6. The system according to claim 5, wherein said wireless connection includes at least one infrared transmitter and receiver.

7. The system according to claim 5, wherein said issuing an alarm further comprises:
forwarding a disruption notice to said other laptops.

8. The system according to claim 5, wherein said desired network topology includes physically arranging said plurality laptops in a desired configuration and establishing said wireless connection between said plurality of laptops.

9. A computer-usable medium embodying computer program code, said computer program code comprising computer-executable instructions configured for:
establishing a desired network topology with a plurality of laptops, wherein each of said plurality of laptops communicates with other laptops utilizing a wireless connection;
in response to establishing said desired network topology, causing a plurality of laptops to enter a lock down state; and
in response to detecting that a disruption in communication has occurred, issuing an alarm.

10. The computer-usable medium according to claim 9, wherein said wireless connection includes at least one infrared transmitter and receiver.

11. The computer-usable medium according to claim 9, wherein said embodied computer program code for issuing an alarm further comprises computer-executable instructions configured for:
forwarding a disruption notice to said other laptops.

12. The computer-usable medium according to claim 9, wherein said desired network topology includes physically arranging said plurality laptops in a desired configuration and establishing said wireless connection between said plurality of laptops.
